(19) United States
(12) Patent Application Publication
(10) Pub. No.: US 2005/0139461 A1
(43) Pub. Date: Jun. 30, 2005

(54) Portable Apparatus for the Remote Operation of a Pistol Grip Circuit Breaker Control Switch

(75) Inventor: Charles Mark McClung, Elkview, WV (US)

Correspondence Address: CHARLES MARK MCCLUNG, 208 WILLOW ST, ELKVIEW, WV, 25071, US

(73) Assignee: Charles Mark McClung, Elkview, WV (US)

(21) Appl. No.: 10/905,272

(22) Filed: Dec. 23, 2004

Related U.S. Application Data
(60) Provisional application No. 60/533,197, filed on Dec. 30, 2003.

(51) Int. Cl. H01H 3/20

(52) U.S. Cl. 200/330

(57) ABSTRACT

A portable actuator for a pistol grip circuit breaker control switch that allows the human operator to be positioned at a safe distance when operating a power circuit breaker. The portable actuator is magnetically held in a proper position relative to the handle of the circuit breaker control switch. An electric motor and gearbox are positioned such that an actuating arm, connected to the output shaft of the gearbox, extends to both sides of the circuit breaker control switch handle. Operation of the cord-connected remote control station will cause the actuating arm to rotate the pistol grip circuit breaker control switch in either a clockwise or counter-clockwise direction, resulting in the circuit breaker opening or closing.

This application is based on U.S. Provisional Application No. 60/533,197 filed on Dec. 30, 2003, and claims the benefit thereof for priority purposes.

### FIELD OF THE INVENTION

The invention relates to the operation of pistol-grip circuit breaker control switches, more specifically, a portable device that facilitates the remote operation of pistol grip control switches.

### BACKGROUND OF THE INVENTION

In utility and industrial power systems, it is common for electrically operated power circuit breakers to be controlled from a manually operated, pistol-grip control switch. Typically, the control switch will be mounted in the front of the metal enclosure surrounding the circuit breaker. Whenever there is a desire to open or close such a circuit breaker, a human operator must rotate the handle of the pistol-grip control switch approximately 45° in either a clockwise or counter-clockwise direction, depending upon the desired circuit breaker action. Once the manual rotational force is relaxed, the pistol-grip handle will spring-return to its neutral position.

In order to effect the operation described above, a human operator must stand within arms-reach of the circuit breaker control switch, which also means he or she is in close proximity to the circuit breaker. If the circuit breaker should happen to fail catastrophically, the human operator is at risk of serious injury or death from the resulting arc-blast and flying debris.

Recognizing the potential hazard of personal injury associated with the local operation of electrically operated power circuit breakers, there is a need for a portable, easy-to-use device that provides a means for remotely operating a pistol-grip circuit breaker control switch from a safe distance away from the circuit breaker. The present invention achieves the stated objective without the need of permanently modifying or altering the existing circuit breaker control switch or the breaker's control system wiring.

### SUMMARY OF THE INVENTION

An object of the invention is to provide a portable device that facilitates the remote operation of pistol-grip circuit breaker control switches by means of an electrically driven actuator. Another object of the present invention is to provide a portable device that is operated from a cable-connected control station that allows the human operator to be positioned a safe distance away from the circuit breaker that is being operated. Yet another object of the invention is to provide a portable actuator that is suitable for the remote operation of a variety styles of pistol-grip circuit breaker control switches. Yet another object of this invention is to provide a portable actuating device that is magnetically affixed to the metal enclosure in which the circuit breaker control switch is mounted, in order to facilitate portable use of the invention, without the need of permanently modifying or alter the control switch.

In keeping with the principles of the present invention, the objects listed above and others are achieved by providing a portable device that is suitable for operating a variety of styles of pistol-grip circuit breaker control switches. The portable actuator is comprised of an electrically-driven motor and gearbox, a position encoder associated with the output shaft of the motor and gearbox, and an actuating arm that is attached to the output shaft of motor and gearbox, holding magnets for attaching the portable actuator to the sheet metal enclosure in which the pistol grip control switch is mounted, a controller for operating the motor, and a cable-connected control station that can be operated from a distance away from the actuator.

The electrically-driven motor and gearbox is attached to a light-weight frame that supports the motor and gearbox and properly positions the actuating arm in relation to the pistol-grip handle of the circuit breaker control switch. The supporting frame and actuator assembly are held in the proper position, relative to the pistol-grip handle, by means of magnets that are attached to the supporting frame and magnetically attach to the sheet metal enclosure in which the circuit breaker control switch is mounted. The actuating arm is fashioned in such a way as to engage the pistol-grip handle of the control switch that is to be operated.

The portable actuator is operated from a remote distance by means of a control station that is connected to the actuator by a control cable. The remote control station monitors the current drawn by the actuator, as well as the position of the actuator shaft, to determine when the pistol-grip handle has been rotated to its maximum limit from the neutral position. At the extreme limit of rotation, the amount of current drawn by the motor will increase, without further rotation of the shaft occurring.

Other objects, features, characteristics and method of operation of the present invention, as well as the function and assembly of its elements will become more apparent in the “Detailed Description of the Invention” and accompanying drawings and claims, all of which form part of this specification.

### BRIEF DESCRIPTION OF THE SEVERAL VIEWS OF THE DRAWINGS

The various embodiments and features of the invention will be clearly depicted in the following drawings:

FIG. 1 is a side view of the actuator, as it would appear when positioned to operate a pistol-grip control switch.

FIG. 2 is a view looking up at the bottom of the actuator, as it would appear when positioned to operate a pistol-grip control switch.

FIG. 3a is a view of the actuator as it would appear when positioned to operate a pistol-grip control switch, looking horizontally and parallel with the axis of rotation of the pistol-grip control switch, with the switch handle in its neutral position.

FIG. 3b is a view of the actuator as it would appear when positioned to operate a pistol-grip control switch, looking horizontally and parallel with the axis of rotation of the pistol-grip control switch, with the switch handle in its clockwise, or close, position.

FIG. 3c is a view of the actuator as it would appear when positioned to operate a pistol-grip control switch, looking horizontally and parallel with the axis of rotation of the pistol-grip control switch, with the switch handle in its counter-clockwise, or trip, position.

FIG. 4a is a plan view of the actuating arm that engages the pistol-grip handle of the control switch.

FIG. 4b is a partial exploded view of the actuating arm.

FIG. 4c is a perspective view of the actuating arm.

FIG. 5 is a view of the base of the actuator frame that would be in contact with the surface of the enclosure in which the pistol-grip control switch is mounted, when the actuator is in position to operate the control switch.

FIG. 6 is a side view of the actuator, depicting the method of positioning and removing the actuator

FIG. 7 is an illustration of the portable actuator and remote control station.

### DETAILED DESCRIPTION OF THE PREFERRED EMBODIMENTS

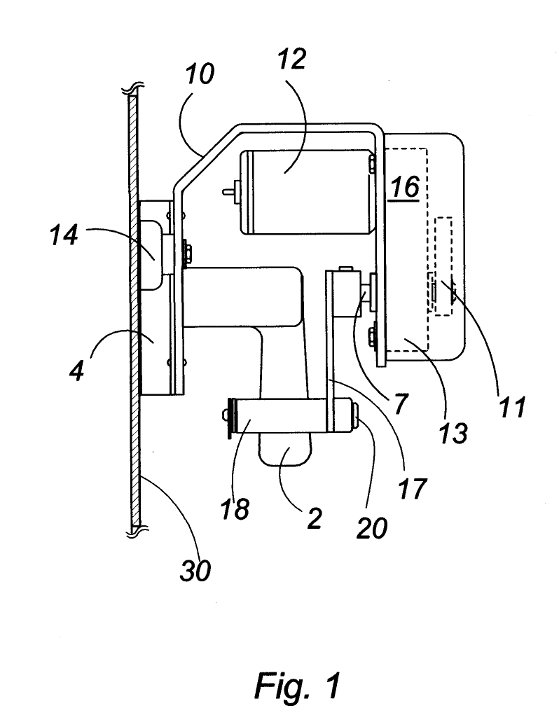

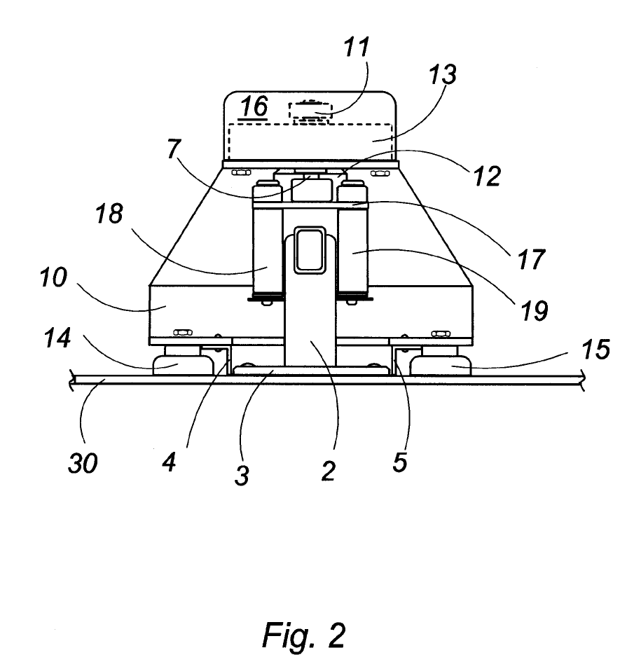

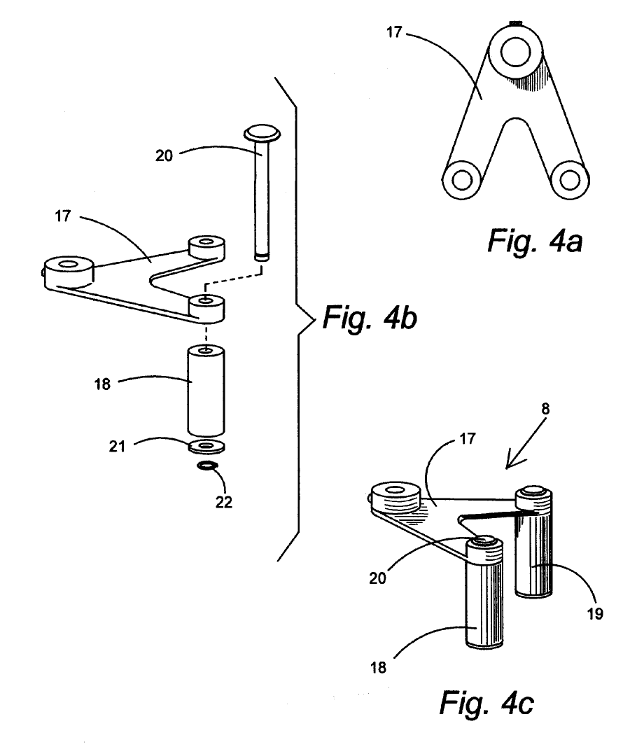

With reference to FIGS. 1 and 2, an exemplary embodiment of a portable actuator assembly 1 for the remote operation of pistol-grip circuit breaker control switches is shown. The portable actuator includes a light weight support frame 10; an electric motor 12; a gearbox 13 with a position encoder 11 associated with the gearbox output shaft 7, affixed to the support frame 10 and disposed in protective cover 16; an actuating arm assembly 8, as best shown in FIG. 4c; and a remote control station 23 and power supply 25.

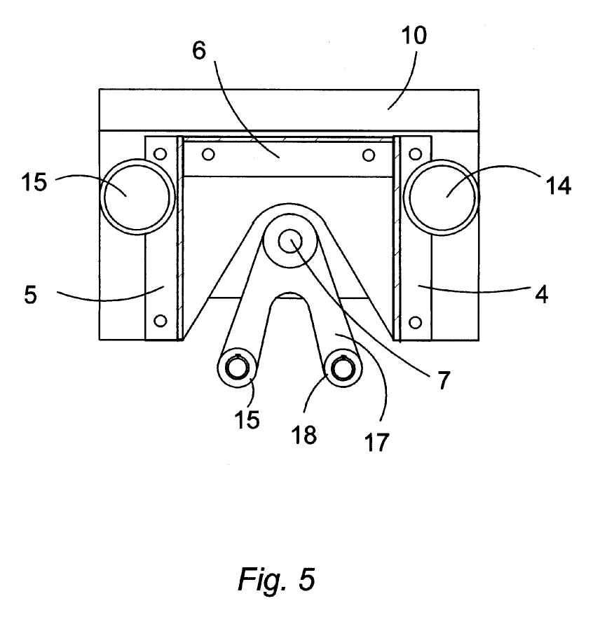

In FIG. 5, the spacing of the aligning angles 4, 5 and 6 on the base of the support frame is such that the distance between the right and left aligning angles 4 and 5 is greater than the width of the escutcheon plate 3 of the pistol grip control switch. The combination of the physical arrangement of the aligning angles 4, 5 and 6 that are attached to the base of the support frame 10, and shape of the portion of the support frame on which the aligning angles are attached, ensure that the actuator assembly 1 is positioned such that the axis of rotation of the gearbox output shaft 7 approximates the axis of rotation of the pistol grip handle 2. Permanent magnets 14 and 15 are attached to the base of the support frame 10, on either side of the aligning angles 4, 5 and 6. The support frame 10 is held in the proper physical position, relative to the pistol grip control handle 2, by means of the magnetic attraction of the permanent magnets 14 and 15 to the sheet metal enclosure 30 in which the pistol grip switch assembly is mounted.

As depicted in FIG. 1 and FIG. 2, an electric motor 12 and gearbox 13 are affixed to the support frame 10. The gearbox 10 has a rotatable shaft 7. An actuating arm 17 is directly coupled to the gearbox output shaft 7. FIG. 4c best shows the embodiment of the actuating arm assembly 8. As shown in FIG. 4a, the actuating arm 17 is shaped in such a manner that the two fingers of the actuating arm radiate at approximately 45° of separation from each other. As shown in FIG. 4c, two anti-friction rollers 18 and 19 are supported from each of the fingers of the actuating arm 17 by a pin 20 which passes through the actuating arm 17 and the anti-friction rollers 18 and 19. Typical for the right and left anti-friction rollers, 18 and 19, FIG. 4b shows that anti-friction roller 18 is supported from the actuating arm by a support pin 20, and is held on the support pin 20 by a washer 21 and snap ring 22. When the portable actuator assembly 1 is properly positioned to operate a pistol grip control switch, the actuating arm assembly 8 is positioned such that an anti-friction roller, 18 and 19, is on each side of the pistol grip handle 2. When the portable actuator assembly 1 is commanded from the remote control station 23 to operate, the rotational force of the gearbox shaft 7 is transmitted to the pistol grip handle 2 by one of the anti-friction rollers 18 or 19 pressing against one side or the other of the pistol grip handle 2, depending upon the desired action of opening or closing the circuit breaker.

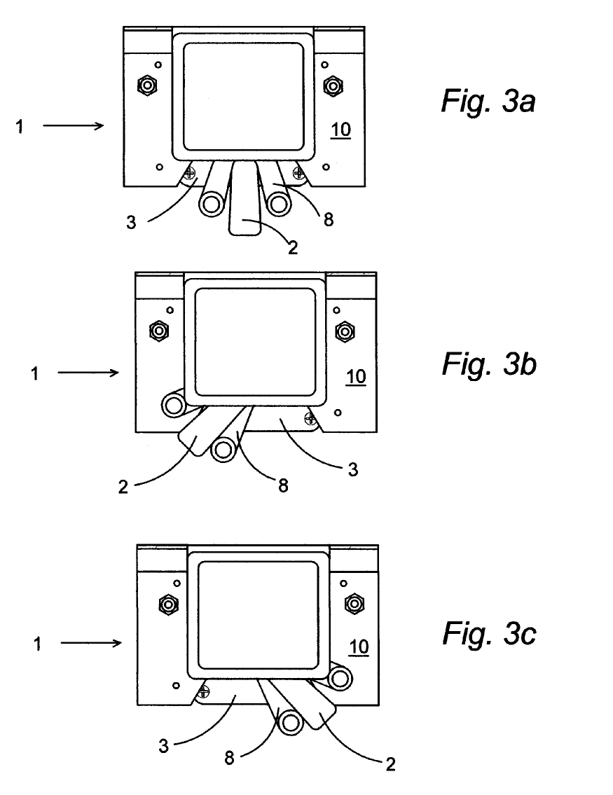

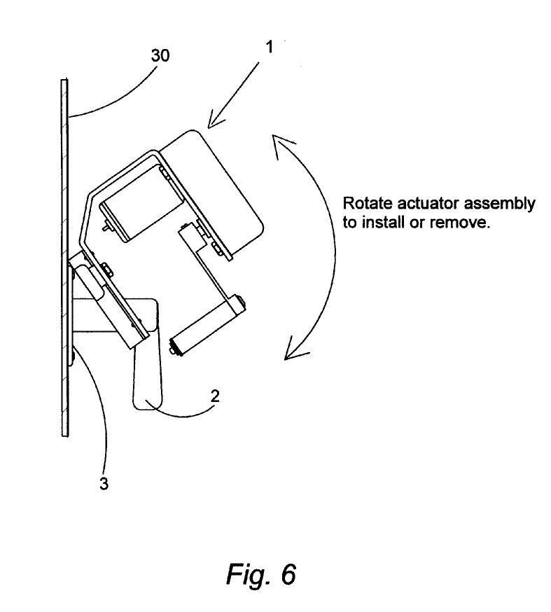

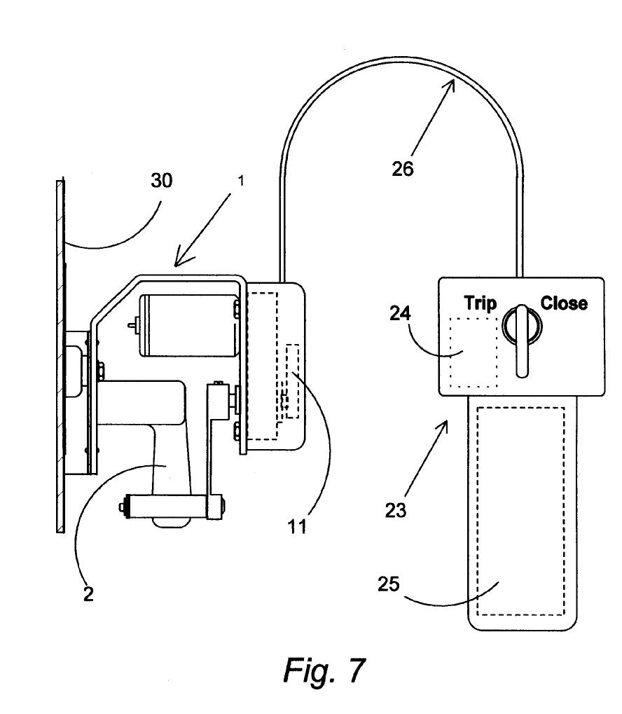

FIG. 6 depicts the method of positioning the portable actuator assembly 1 to operate a pistol grip control switch handle 2. Before positioning the actuator assembly 1 relative to the pistol grip control switch handle 2, the operator will activate the remote control station 23 to ensure the actuating arm 17 is in the neutral position as shown in FIG. 3a. The actuator is then ready to be positioned for operation. FIG. 6 shows the position that the actuator assembly 1 must be held in order to properly position it relative to the escutcheon plate 3 and the pistol grip handle 2. By holding the actuator at the angle shown, relative to the plane of the metal enclosure 30 in which the control switch is mounted, the holding magnets 14 and 15 are kept separated from the metal enclosure 30. Once the top aligning angle 6 is in contact with the top edge of the control switch escutcheon plate 3, the actuator is rotated in a downward motion, as shown in FIG. 6 with the axis of rotation being the edge of the top aligning angle 6 that is in contact with the switch escutcheon plate 3. As the actuator assembly 1 is rotated downward, the holding magnets 14 and 15 come into contact with the surface of the sheet metal enclosure 30 in which the pistol grip control switch is mounted. The magnetic attraction of the holding magnets 14 and 15 secure the actuator assembly 1 to the sheet metal enclosure 30 and keep the actuator arm assembly 8 in the proper physical relationship with the pistol grip handle 2. The proper position of the actuator arm assembly 8 relative to the pistol grip handle 2, is clearly shown in FIG. 1 and FIG. 2.

In order to remove the actuator assembly 1, the process described above and depicted in FIG. 6 is reversed. The actuator assembly 1 is rotated up, with the axis of rotation being the top aligning angle 6 against the top of the pistol grip control switch escutcheon plate 3. As a result, the holding magnets 14 and 15 are separated from the sheet metal enclosure 30 that supports the pistol grip switch, allowing the actuator assembly 1 to be lifted clear of the control switch.

Once the actuator assembly 1 is properly positioned to operate a pistol grip control switch, the human operator will activate a switch on the remote control station 23, that is connected to the portable actuator by means of a flexible control cable 26. Operation of the switch on the remote control station 23 will command the actuator arm assembly 8 to rotate the pistol grip handle in the direction that will result in the desired circuit breaker action (trip or close). The actuator motor 12 derives operating power from the power supply 25 housed inside remote control station 23. Control of the actuator motor 12 is managed by means of a micro controller 24 which is also housed inside remote control station. The micro controller 24 monitors the amount of current that is drawn by the actuator motor 12 and the relative position of the actuator arm assembly 8 as indicated by the position encoder 11 that is associated with the output shaft 7 of the gearbox. If the micro controller 24 senses that the actuating arm assembly 8 has rotated 20° or more in either direction and the motor current rate of rise has dramatically increased, it will cause the motor to stop and reverse direction until it reaches the neutral (starting) position, where it will stop the motor 12 and apply regenerative braking.

The above description of the preferred embodiments have been given by way of example. From the disclosure given, those skilled in the art will not only understand the present invention and its attendant advantages, but will also find apparent various changes and modifications to the structures disclosed. It is sought, therefore, to cover all such changes and modifications as fall within the spirit and scope of the invention, as defined by the appended claims, and equivalents thereof.

1. A portable actuator, for the remote operation of pistol grip circuit breaker control switches, comprised of:
a frame for supporting and positioning the portable actuator in relationship to the pistol grip handle,
an electric motor and associated gearbox mounted to the supporting frame,
holding magnets for temporarily holding the actuator frame in the proper position relative to the pistol grip handle, by magnetic attraction to the sheet metal enclosure in which a pistol grip control switch is mounted,
an actuating arm for transmitting the rotational force produced by the motor and gearbox to the pistol grip handle of the circuit breaker control switch,
a device for sensing the angular position of the actuating arm,
a controller for starting, stopping and reversing the motor,
a control station operatively associated with the actuator for the purpose of operating the actuator from a location that is remote from the actuator.

2. The apparatus of claim 1, further comprising an encoder associated with the gearbox to track the position of the actuating arm, to communicate to the controller for controlling the motor where said encoder is either:
a digital absolute position indicating encoder,
a limit switch, or,
a variable resistance potentiometer.

3. The holding magnets as claimed in claim 1, wherein said magnets are permanent magnets.

4. The holding magnets as claimed in claim 1, wherein said magnets are electromagnets.
